(19) United States
(12) Patent Application Publication
(10) Pub. No.: US 2025/0230001 A1
(43) Pub. Date: Jul. 17, 2025

(54) METHODS AND SYSTEM FOR LOADING AND TRANSFERRING GOODS CONTAINERS

(71) Applicant: Safelog GmbH, Markt Schwaben (DE)

(72) Inventor: Michael WOLTER, Schliersee (DE)

(21) Appl. No.: 19/169,861

(22) Filed: Apr. 3, 2025

Related U.S. Application Data
(63) Continuation of application No. PCT/EP2023/078514, filed on Oct. 13, 2023.

(30) Foreign Application Priority Data
Oct. 17, 2022 (DE) 10 2022 127 082.3

(51) Int. Cl. B65G 67/08

(52) U.S. Cl. CPC B65G 67/08; B65G 2201/0235

(57) ABSTRACT

A method and a system for loading and removing a goods container into and from a receiving container mounted on an AGV at a stationarily mounted loading station is provided. The loading station has a lifting device with a loading fork with two loading tines which can be moved vertically between an upper conveying level and a lower conveying level. Two vertical slots are provided in a side wall of the receiving container, which extend from the upper edge of the side wall to a lower section of the receiving container.

### CROSS REFERENCE TO RELATED APPLICATIONS

This application is a continuation of International Application No.: PCT/EP2023/078514, filed Oct. 13, 2023, which claims priority to German Application No. 10 2022 127 082.3, filed Oct. 17, 2022, the contents of each of which are incorporated by reference herein.

### FIELD OF THE INVENTION

The present invention relates to various related methods and a system for loading goods containers or for transferring goods delivered in goods containers between different goods containers.

### BACKGROUND

Systems and methods for handling or loading containers, pallets or workpieces are known from the prior art. DE 10 2021 131651 A1 describes a pallet loading and unloading system and an associated method, whereby the handling of the transport aids used is fully automatic. DE 10 2019 214 088 A1 discloses a handling device for use on a machine tool for picking up or transferring a workpiece. DE 10 2022 118 506 A1 describes a driverless transport system for transporting products from a printing machine. DE 7404016 U discloses a device for loading piece goods onto a loading area of a lorry.

In practice, logistics centres or other transshipment warehouses often have to sort goods delivered in standardised goods containers (e.g. so-called KLT containers) and reload them into other goods containers, e.g. to distribute the goods delivered in a first goods container to a number of other goods containers, which then have to be dispatched to different recipients or (temporarily) stored at different locations within the warehouse.

In the state of the art, the goods containers filled with goods are typically transported within the warehouse in a suitable manner to corresponding reloading stations by means of conventional, permanently installed conveyor technology, where the goods are then reloaded between the various goods containers and from where the appropriately loaded goods containers can be transported away again using standard conveyor technology.

However, the methods and systems currently used in this context are comparatively cost-intensive and not very flexible with regard to adaptation to different warehouse designs, so that the present invention is intended to provide corresponding methods and systems with which a high degree of flexibility in equipping a wide variety of warehouses with such systems is to be provided at comparatively low cost.

### SUMMARY

Various methods and systems are provided in the context of the present invention, namely a method for loading a goods container into a receiving container mounted on an AGV (“automated guided vehicle”) at a stationary mounted loading station, a method for removing a goods container from a receiving container mounted on an AGV at a stationary mounted loading station, a method for transferring goods delivered in goods containers into other goods containers, and a system for loading a goods container into a receiving container mounted on an AGV and for removing a goods container from a receiving container mounted on an AGV.

In a method for loading a goods container into a receiving container mounted on an AGV (“automated guided vehicle”) at a fixedly mounted loading station, it is provided that the loading station has a lifting device with a loading fork with two loading tines which can be moved vertically between an upper conveying level and a lower conveying level, the method having the following steps:
(A1) Positioning the loading fork of the loading station at a suitable height in the upper conveyor level and transporting the goods container to the loading station in the upper conveyor level by means of a conveyor device so that the goods container is carried by the loading fork;
(B1) Positioning of an AGV travelling in the lower conveying level with a receiving container mounted on it to hold the goods container exactly below the goods container carried by the loading fork in the upper conveying level;
(C1) Vertical lowering of the loading fork and the goods container located thereon into the receiving container located below until the goods container is supported on the underside in the receiving container and until the loading tines projecting into a lower section of the receiving container no longer have any contact with the goods container supported inside the receiving container, the receiving container having two vertical slots in a side wall extending from the upper edge of the wall to the lower section to enable the loading fork to be lowered;
(D1) Straight-ahead travel of the AGV with the receiving container located on it and the goods container located inside the receiving container in the longitudinal direction of the loading tines away from the loading station, so that the loading tines of the stationary loading station are moved out of the receiving container due to the straight-ahead travel of the AGV.

In a method for removing a goods container from a receiving container mounted on an AGV (“automated guided vehicle”) at a fixedly mounted loading station, it is provided that the loading station has a lifting device with a loading fork with two loading tines which can be moved vertically between an upper conveying level and a lower conveying level, the method having the following steps:
(A2) Positioning the loading fork of the loading station at a suitable height in the lower conveyor level and positioning an AGV with a receiving container mounted on it and the goods container located inside the receiving container in front of the loading station;
(B2) Straight-ahead travel of the AGV in the longitudinal direction of the loading tines towards the loading station, so that the loading tines of the loading fork enter a lower section of the receiving container through vertical slots in a side wall of the receiving container due to the straight-ahead travel of the AGV below the goods container;
(C2) Vertical lifting of the loading fork up to the upper conveying level, so that the goods container carried by the loading fork is lifted upwards out of the receiving container and lifted up to the upper conveying level, wherein the vertical slots in a side wall of the receiving container extend up to the upper edge of the wall to enable the loading fork to be lifted out;
(D2) Transfer of the goods container to a conveyor located in the upper conveyor level for further transport of the goods container in the upper conveyor level.

A method for reloading goods delivered in goods containers into other goods containers at a reloading station comprises the following steps:
(A3) Loading of a first goods container filled with the goods to be re-sorted into a receiving container mounted on a first AGV at a stationary mounted loading station;
(B3) Loading a second, empty goods container into a receiving container mounted on a second AGV at a stationary mounted loading station;
(C3) Optionally, loading of at least one further empty or goods-filled goods container into a respective receiving container mounted on a further AGV at a stationarily mounted loading station;
(D3) Moving the at least two AGVs with the receiving containers and goods containers located thereon in the lower conveyor level to a reloading station;
(E3) Manual or automatic reloading of goods from the first goods container into the second goods container at the reloading station and, optionally, reloading of further goods between the different goods containers until the second goods container is filled with the desired goods;
(F3) After completion of the reloading of the goods, moving the various AGV's with receiving containers and goods containers to a loading station and removing the respective goods container from the receiving container mounted on the respective AGV.

A system is used for loading a goods container into a receiving container mounted on an AGV and for removing a goods container from a receiving container mounted on an AGV, and the system comprises accordingly:
a stationary loading station with a lifting device, which has a loading fork with two loading tines that can be moved vertically between an upper conveyor level and a lower conveyor level,
a conveyor system for the supply and removal of goods containers in the upper conveyor level to and from the loading station, and
at least one AGV travelling in the lower conveyor level with a receiving container mounted on it,

The receiving container has at least two vertical slots in a side wall extending up to the upper edge and is designed in such a way that:
(a) for loading a goods container into the receiving container mounted on the AGV, the loading tines of the lifting device carrying a goods container can be lowered vertically with suitable positioning of the AGV, until the goods container is supported on the underside in the receiving container and until the loading tines projecting into a lower section of the receiving container through the vertical slots no longer have any contact with the goods container and can then be moved linearly out of the receiving container by the AGV travelling straight ahead, and
(b) for removing a goods container from the receiving container mounted on the AGV, the loading tines of the loading fork can enter a lower section of the receiving container through the vertical slots when the AGV is travelling in a suitable straight line underneath the goods container and can then be lifted together with the goods container until the goods container has been removed upwards from the receiving container.

In connection with the above-mentioned methods and the above-mentioned system, it should first of all be noted that transport of the goods containers in two conveying levels, namely an upper conveying level and a lower conveying level, is provided. In the upper conveying level there is a conveying device (e.g. a roller or belt conveyor system driven in the usual manner and controllable in a suitable manner), with which the goods containers transferred to the conveying device at a suitable point in the upper conveying level can be fed to the loading station or transported away from it. In the lower conveyor level, which is typically formed by the flat floor of the warehouse, there is at least one AGV that can be moved there with a receiving container permanently mounted on it.

Advantageously, it can be provided that the conveyor device located in the upper conveyor level—at least in the area of the loading station—can be driven under by an AGV located in the lower conveyor level together with a receiving container located on it (and, if necessary, a goods container located in the receiving container).

According to embodiments of the invention, the loading station is mounted in a fixed position and has a lifting device with a loading fork with two loading tines that can move vertically between the upper conveyor level and the lower conveyor level, so that it can transport a goods container supported on the loading tines of the loading fork from the upper to the lower conveyor level (and vice versa).

According to embodiments of the invention, it is provided that a goods container fed to the loading station by the conveying device (in the upper conveying level) in accordance with the methods described herein can be loaded from above by means of the lifting device into a receiving container specifically designed for this purpose and mounted on an AGV, and that a goods container fed to the loading station by an AGV with a corresponding receiving container (in the lower conveying level) can be lifted upwards out of the receiving container in accordance with the methods described herein by means of the lifting device, in order to then transfer this in turn to the conveying device (located in the upper conveying level) for further transport.

Of course, the conveying device located in the area of the loading station in the upper conveying level and the loading station must be designed in such a way that a goods container fed by means of the conveying device can be positioned in the correct position, i.e. as precisely as possible in a predetermined position, on the loading tines of the loading fork of the lifting device, or that a goods container lifted out of a receiving container of an AGV by means of the lifting device and moved to the upper conveying level can be transferred from there to the conveying device in a suitable manner in order to then be transported away by means of the conveying device. Sufficiently precise positioning of the goods container on the loading tines of the loading fork can be supported by appropriate stops on the loading tines.

The goods containers delivered to a loading station by means of conventional conveyor technology can therefore be transferred in a particularly flexible manner and without the need for separate conveyor technology to be installed in the lower conveyor level, at a (permanently installed) loading station to an AGV located in the lower conveyor level (by loading from above into the receiving container mounted on the AGV) and transported there by means of an AGV to any desired location (e.g. to a reloading station).

In the area of the reloading station, various AGVs with receiving containers and goods containers can be positioned in a suitable and easily accessible manner so that goods can be efficiently reloaded between different goods containers—either manually (by a person) or automatically (e.g. by means of a suitable handling device).

Furthermore, a goods container located in a receiving container of an AGV (e.g. after completion of a reloading process) can be flexibly transported to a loading station by means of the AGV, where it can be easily removed from the receiving container and then transferred to the conveyor system located on the upper conveyor level.

To transport each goods container in the lower conveyor level, an AGV with a receiving container permanently mounted on it is therefore required, whereby it may also be possible for two receiving containers to be mounted on one AGV to hold one goods container each.

Furthermore, a system according to embodiments of the invention can preferably have several loading stations in order to enable a transfer of goods containers at various points between the AGVs travelling in the lower conveying level and the conveying devices located there in the upper conveying level.

If a number of loading stations are installed in a warehouse and suitably connected to a conveyor system running in the upper conveyor level there, each AGV with the receiving container installed on it can receive a goods container delivered there at a first loading station and return it to the conveyor system running there at a later time—for example after goods have been transferred between different goods containers—at another (or even the same) loading station.

According to embodiments of the invention, a receiving container permanently mounted on an AGV serves to accommodate a goods container and is designed accordingly for this purpose, wherein the receiving container must obviously be designed such that it permits the loading of a goods container in accordance with the methods described herein and/or the removal of a goods container in accordance with the methods described herein.

A receiving container (with a typically rectangular cross-section) which can be used within the scope of the invention advantageously has four side walls, wherein two vertical slots extending vertically downwards from the upper edge of the side wall are provided in (at least) one side wall, the spacing and width of which is selected in such a way that the two (always horizontally extending) loading tines—with suitable positioning of the AGV together with the receiving container at the loading station—can be lowered into the receiving container in the region of the vertical slots without contact with the receiving container for the purpose of loading a goods container into the receiving container when the loading fork is lowered vertically in accordance with step (C1).

Of course, the vertical length of the two vertical slots must extend so far into a lower section of the receiving container that a goods container carried by the loading tines in the sense of process step (C1) can be set down in the lower section of the receiving container on a base or support structure provided inside the receiving container and that the loading tines can then—without contact with the goods container and receiving container by travelling straight ahead of the AGV in the sense of process step (D1)—extend laterally out of the receiving container again. The base or support structure inside the receiving container supporting the goods container on the underside must also obviously have corresponding recesses for this purpose, so that the loading tines can be lowered to below the floor level of the goods container supported inside the receiving container according to step (C1) or so that the suitably positioned loading tines can enter the receiving container through the lateral vertical slots when the AGV drives straight ahead according to process step (B2) underneath the goods container.

In a particularly expedient embodiment of the present invention, it may be provided that the clear width of the receiving containers used in the context of the invention is slightly larger than the outer dimensions of the goods container to be accommodated in the receiving container, so that when the goods container is positioned centrally in the receiving container, there is a gap between the inner wall of the receiving container and the outer wall of the goods container accommodated therein. In this way, it can be achieved that there is a certain clearance with regard to the accuracy with which an AGV must be positioned in process step (B1) for loading a goods container underneath the goods container.

In this case, however, it is particularly advantageous if a brush arrangement is provided on the inner wall of the overflow container, which at least largely closes the circumferential gap between the overflow container and the goods container. Such a brush arrangement can prevent any goods protruding or spilling out of the top of the goods container from falling into the slot between the receiving container and the goods container during transport of the goods container located in the receiving container with the AGV and/or during the reloading of goods at a reloading station. The brush arrangement is also sufficiently flexible to reliably fulfil the above purpose even if the positioning of the goods container within the receiving container is not exactly centred. It is advantageously provided at such a height on the inner wall of the receiving container that the brushes on the outside of the goods container positioned as intended inside the receiving container rest in the area of the upper edge or just below the upper edge of the goods container.

Furthermore, it is advantageous in the context of the invention if the side walls of the receiving container project vertically beyond the walls of the goods container accommodated in the receiving container. This is particularly advantageous if—as is often the case in practice—overfilled goods containers with goods protruding or spilling out of the goods container (e.g. to or from a reloading station) have to be transported.

In yet another preferred further development of the present invention, it can be provided that both loading tines of the loading fork of a loading device have a motor-driven conveyor belt on their upper side, with which a goods container supported on the loading tines can be transferred in the upper conveying level to a conveying device located directly in front of the loading fork or with which a goods container fed in the upper conveying level by the conveying device can be suitably positioned on the loading tines. The two conveyor belts—located on the two loading tines of the loading fork—are advantageously driven by a drive motor, which can be arranged in a space-saving manner, e.g. at the rear of the loading fork, and can be connected to a central control unit for the system according to the invention, e.g. by means of a suitable bus connection (e.g. CAN bus).

With regard to the “Automated Guided Vehicles” (AGV's) used in the context of the invention, which are often also called driverless transport vehicles, it should also be mentioned that such AGV's are sufficiently known from the prior art in a variety of configurations and are already used in a variety of ways for the autonomous transport of goods in industrial warehouses, production facilities or logistics centres. Such AGVs, as they are also used in the context of the present invention, can carry a goods container on top (or in the present case: a receiving container for a goods container to be accommodated therein), whereby the goods container can of course be loaded with goods, and are typically equipped with a suitable drive with which the AGV can, for example, travel straight ahead in the forwards/backwards direction and perform rotations.

Suitable control and guidance systems for controlling the route and other functions of such AGVs are also already known from the state of the art in a variety of practical designs.

Obviously, within the framework of the present invention, it can be advantageously provided that the system according to the invention has a central or distributed control unit which is set up to control the supply and removal of various goods containers to and from the at least one loading station by means of the respective conveyor device, the drive of any conveyor belts on the upper side of the loading tines of the loading forks of the at least one loading station, the use of the at least one AGV with suitable specification of the routes to be travelled for this purpose and the necessary control of the drive of the lifting device of the at least one loading station (fully automatically).

Both, the at least one AGV and the control unit, are advantageously equipped with suitable bi-directional communication interfaces, which can preferably be based on one or more of the data communication standards for wireless communication that are usually used for this purpose. The drive units of the lifting device and any conveyor belts on the loading tines of the at least one loading station can also be equipped with corresponding communication interfaces for wired or wireless communication with the central control unit, which is possible, for example, by connection using a suitable bus system (e.g. CAN bus).

When using AGVs with optical sensors, it is particularly helpful if at least one floor marking that can be recognised by the transport vehicle is fitted in the area of each loading station, as this is a simple way of ensuring that the AGV is positioned precisely at the loading position. Furthermore, the routes to be used by the AGV can be marked by suitable floor markings placed along the routes, which facilitates the precise guidance of the transport vehicles on the routes to be covered by it. Such guidance systems, which enable reliable navigation for AGVs with the aid of ground markings and suitable sensors in/on the AGV, are well known from the state of the art.

### BRIEF DESCRIPTION OF THE DRAWING

In the following, embodiments of the invention are explained in more detail with reference to the drawings.

FIGS. 1A-1C show various views of an AGV that can be used according to the invention with a receiving container mounted on it.

FIG. 2A shows a top view of a loading station.

FIGS. 2B and 2C show a side view and a rear view of the loading station from FIG. 2A together with a goods container located on the loading tines in the upper conveying level and an AGV positioned exactly below it in the lower conveying level with a receiving container mounted on it.

FIGS. 3A-3D show various side views of a loading station to illustrate the loading of a goods container into a receiving container mounted on an AGV.

FIGS. 4A-4D show various side views of a loading station to illustrate the unloading of a goods container from a receiving container mounted on an AGV.

FIGS. 5A-5C show various (partial) plan views of a system according to the invention when carrying out a method according to the invention for transferring goods between different goods containers.

FIGS. 6A and 6B show a top view and a side view of a further embodiment of a lifting device in which the loading tines of the loading fork are equipped with a conveyor belt.

### DETAILED DESCRIPTION OF THE PREFERRED EMBODIMENTS

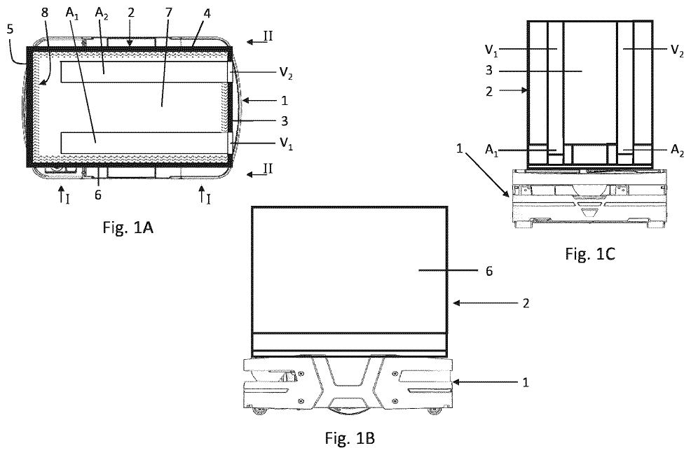

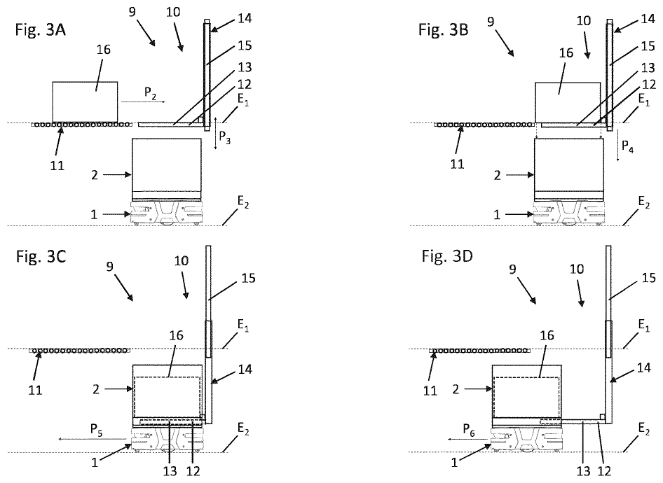

FIG. 1A shows a plan view of an AGV 1 used in the context of the present invention together with a receiving container 2 mounted thereon, wherein the receiving container 2 serves to hold a goods container—not yet shown in FIGS. 1A-C—which will be explained in more detail below with reference to FIGS. 3A-3D, among other things. FIGS. 1B and 1C show the AGV 1 with receiving container 2 shown in FIG. 1A in two different side views according to view arrows I-I (FIG. 1B) and view arrows II-II (FIG. 1C).

The cross-section of the rectangular receiving container 2 has four side walls 3, 4, 5, 6 and it is open at the top so that—as will be explained in more detail below—a goods container can be loaded into the receiving container 2 from above. The receiving container 2 has a base or support structure 7 in its interior, on which a goods container can be supported on the underside.

Two vertical slots V₁, V₂ are provided in the side wall 3 on the right-hand side in FIG. 1A and facing the viewer in FIG. 1C, extending from the upper edge of the side wall 3 to a lower region of the receiving container 2, which allow the loading tines carrying the goods container to pass into the interior of the receiving container 2 during loading and unloading of a goods container. Furthermore, recesses A₁ and A₂ are provided in the base or support structure 7, which allow the loading tines to be lowered below the level of the base or support structure 7 or the loading tines to be inserted into or withdrawn from the receiving container 2 below the goods container supported on the base or support structure 7, which is carried out in accordance with the invention by the AGV travelling in a straight line suitably positioned at a loading station, as will be explained in more detail below.

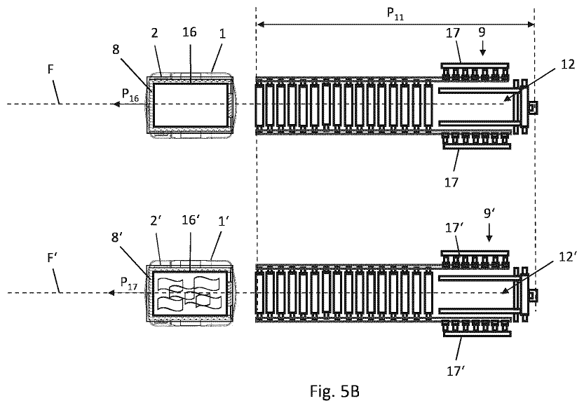

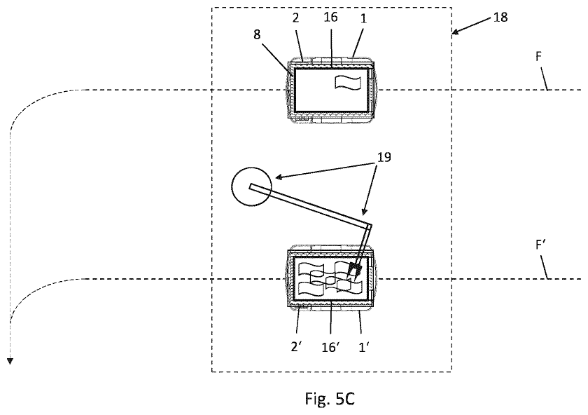

Furthermore, FIG. 1A also shows a brush arrangement 8 attached to the inner wall of the receiving container 2, with which, as will be explained in more detail below with reference to FIG. 5B, a gap arising between the receiving container 2 and a goods container accommodated therein is closed or concealed so that no goods from the goods container can fall in there during transport of the goods container or during reloading of goods.

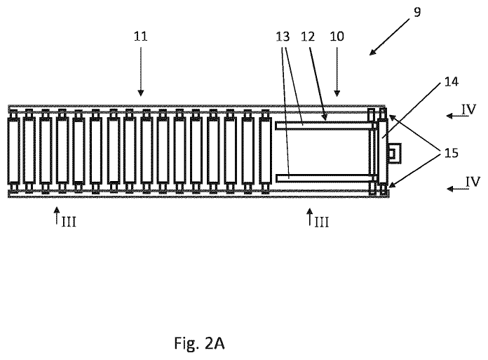

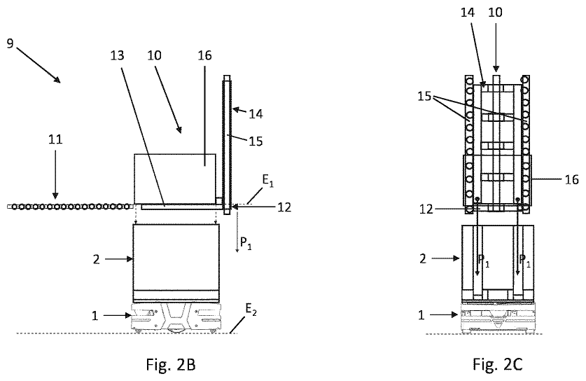

FIG. 2A shows a loading station 9 with a lifting device 10 and a conveying device 11 that can be used in the context of the invention in a plan view, FIGS. 2B and 2C in turn showing the loading station 9 shown in FIG. 2A in two different side views according to view arrows III-III (FIG. 2B; side view) and view arrows IV-IV (FIG. 2C; rear view).

The conveyor 11, which is a roller conveyor in the embodiment example shown, is used to feed or remove goods containers 16 (fed at other points of the conveyor 11) to or from the lifting device 10 in an upper conveyor level E₁. The conveyor 11 extends much further than shown in the various drawings and is suitably connected on the side facing away from the lifting device 10 to the conveyor technology typically already present in a logistics centre, transshipment warehouse, etc.

The lifting device 10 of the loading station 9 has a loading fork 12 with two horizontal and parallel loading tines 13, the loading fork 12 being attached to a base structure 14, which can be moved vertically within two roller arrangements 15 supporting the base structure 14 on both sides for raising and lowering the loading fork 12 between two end positions assigned to the upper conveying level E₁ and the lower conveying level E₂, which can be achieved by a drive not shown in FIGS. 2A-2C.

In addition to the loading station 9, FIGS. 2B and 2C also show a goods container 16 positioned on the loading tines 13 of the loading fork 12 and an AGV 1 suitably positioned exactly below the goods container 16 with a receiving container 2 located on it. If the loading fork 12 together with the goods container 16 supported on the loading tines 13 is now lowered according to the arrows P₁ from FIGS. 2B and 2C, then the goods container 16 can be set down inside the receiving container 2, as the loading tines 13 can reach into the interior of the receiving container 2 through the vertical slots V₁, V₂ during the entire lowering process.

The loading of a goods container 16 into the receiving container 2 mounted on an AGV and the removal of a goods container 16 located in the receiving container 2 is explained in more detail below with reference to FIGS. 3A-3D (loading) and 4A-4D (removal).

In order to load a goods container 16 into the receiving container 2 mounted on an AGV 1, the loading fork 12 of the loading station 9, which can be moved vertically in accordance with double arrow P₃ in FIG. 3A, must first be positioned at a suitable height in the upper conveying level E₁, as shown in FIG. 3A, and a goods container 16 is transported to the loading station 9 in the upper conveying level E₂ by means of the conveying device 11 in accordance with arrow P₂ (see FIG. 3A), so that the goods container 16 is finally carried by the loading fork 12 or the loading tines 13 in an intended position, which can be predetermined by suitable stop elements (see FIG. 3B). Then, for the purposes of process step (B1), which can also be carried out at the same time or before process step (A1), the AGV 1 travelling in the lower conveying level E₂ with the receiving container 2 mounted on it for receiving the goods container 16 must be positioned exactly below the goods container 16 carried by the loading fork 13 in the upper conveying level E₁, whereby the AGV 1 and the receiving container 2 must obviously also be orientated in such a way that the vertical slots V₁, V₂ are arranged exactly below the two loading tines 13 of the loading fork 12. The AGV 1 is already recognisably positioned in this way in FIGS. 3A and 3B. The loading fork 12 and the goods container 16 located on it can then be lowered vertically into the receiving container 2 located underneath in accordance with arrow P₄ in FIG. 3B until the goods container 16 is supported on the underside in the receiving container 2 (by the base or support structure 7 there—see FIG. 1A) and until the loading tines 13 projecting into a lower section of the receiving container 2 no longer have any contact with the goods container 16 supported inside the receiving container 2 (see FIG. 3C). This lowering of the loading fork 12 is made possible by the two vertical slots V₁, V₂ in a side wall 3 of the receiving container 2 and by the recesses A₁, A₂ in the base or support structure 7 of the receiving container 2. The loading tines 13 can then be moved out of the receiving container 2 mounted on the AGV 1 in the sense of process step (D1) by driving the AGV 1 straight ahead in accordance with arrow P₅ or P₆ in the longitudinal direction of the loading tines 13 of the fixed loading station 9 (see FIGS. 3C and 3D). The AGV 1 together with the receiving container 2 mounted on it and the goods container 16 located therein can then be moved freely in the lower conveyor level E₍₂₎.

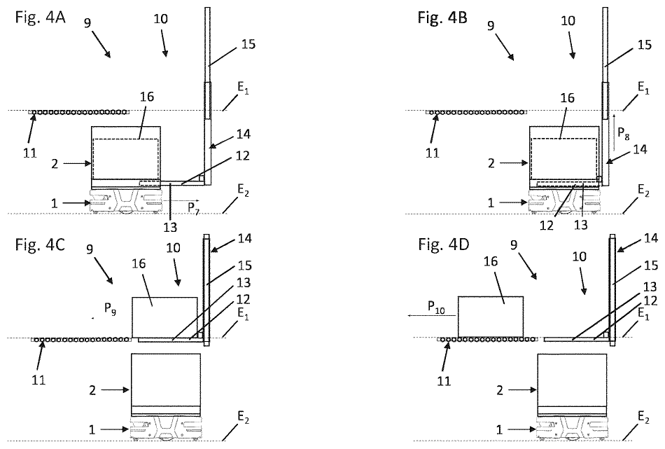

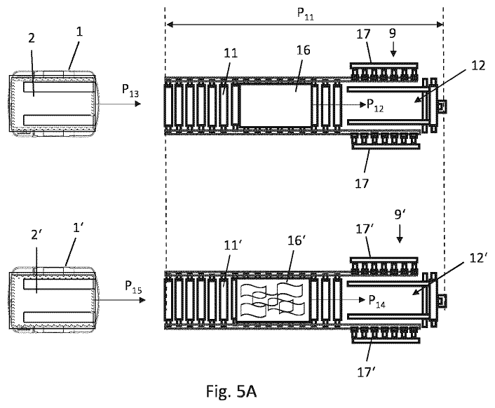

For the removal of a goods container 2 from a receiving container 2 mounted on an AGV 1 as shown in FIGS. 4A-4D, the loading fork 13 of the loading station 9 must first be positioned at a suitable height in the lower conveyor level E₂ (see FIG. 4A) and the AGV 1 must be suitably positioned in front of the loading station 9 in accordance with process step (A2). Then, by driving the AGV 1 straight ahead in the longitudinal direction of the loading tines 13 towards the loading station 9 in accordance with arrow P7 from FIG. 4A, it can be ensured that the loading tines 13 of the loading fork 12 enter a lower section of the receiving container 2 through the vertical slots V₁, V₂ in the side wall 3 of the receiving container 2 due to the straight ahead travel of the AGV 1 below the goods container 16 (cf. FIGS. 4A and 4B). Then, according to process step (C2), the loading fork 12 is lifted vertically up to the upper conveying level E₁, so that the goods container 16 carried by the loading fork 12 is lifted upwards out of the receiving container 2 and lifted up to the upper conveying level E₁ (see FIG. 4C). The goods container 16 can then be transferred in the sense of process step (D2) according to arrows P₉ and P₁₀ from FIGS. 4C and 4D to the conveying device 11 located in the upper conveying level E₁ for further transport of the goods container 16.

Finally, FIGS. 5A, 5B and 5C illustrate again in a plan view a further embodiment of the invention, in which two loading stations 9 and 9′ of the type already described are provided, wherein in FIGS. 5A and 5B, the area marked by the double arrow P₁₁ shows a top view of the upper conveying level E₁, while the area to the left of it shows exclusively a top view of the lower conveying level E₂, so that the further course of the conveying devices 11 and 11′ leading to the loading stations 9 and 9′ is not recognisable there.

In the upper area of FIG. 5A, an empty goods container 16 is conveyed in the direction of the arrow P₁₂ to the loading station 9 shown at the top in FIG. 5A by the conveying device 11, which is designed as a roller conveyor. In the lower area of FIG. 5A, a goods container 16 filled with goods is conveyed in the direction of the arrow P₁₄ to the loading station 9′ shown in FIG. 5A below by the conveying device 11′, which is designed as a roller conveyor. At both loading stations, two lateral guide elements 17 or 17′ with roller drive are provided in the upper conveying level E₁ on both sides of the loading fork 12 or 12′, with the aid of which the goods container 16 or 16′ delivered by the respective conveying device 11 or 11′ can be positioned correctly on the respective loading fork 12 or 12′. In the lower conveyor level E₂, there are two AGVs 1, 1′, each with a receiving container 2, 2′ of the type already described above mounted on it, which are also moved in the direction of the arrows P₁₃ or P₁₅ to a loading station 9 or 9′ in order to take up position there exactly below the point at which the goods containers 16 or 16′ are positioned on the respective loading fork 12 or 12′. Then, by lowering the loading forks 12, 12′, the respective goods container 16, 16′ can be loaded into the receiving container 2, 2′ located below, as already described.

The AGVs 1, 1′ together with the receiving containers 2, 2′ located thereon and the goods containers 16 or 16′ located therein can then be moved away again from the loading station 9 or 9′ (see FIG. 5B). FIG. 5B also clearly shows that the brush arrangements 8 or 8′ provided on an inner wall of the receiving container 2 or 2′ at least largely close the circumferential gap (except in the area of the vertical slots V₁, V₂) between the receiving container 2 or 2′ and the goods container 16 or 16′ accommodated therein.

The AGVs 1, 1′, each loaded with a goods container 16, 16′, can then be moved along the respective arrows P₁₆, P₁₇ (see FIG. 5C) on a respective associated track F or F′ to a reloading station 18 (see FIG. 5C). At the reloading station, goods can then be reloaded from the filled goods container 16′ into the previously empty goods container 16—either automatically by means of a handling robot 19 shown schematically or manually by suitable personnel. It is evident that, if necessary, more than two AGVs with over and goods containers can be moved to a reloading station 18 in order to reload goods there between several goods containers.

After carrying out the desired reloading processes, the various AGVs 1, 1′ can then be moved to one of the loading stations 9, 9′ or to another loading station (not shown) in order to transfer the respective goods containers 16, 16′ to the conveyor device 11, 11′ located in the upper conveyor level E₁ for further transport.

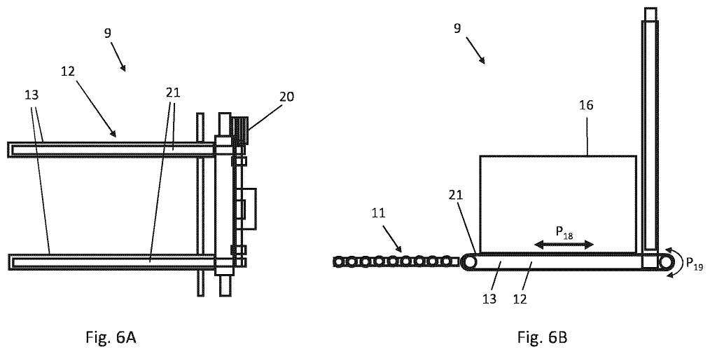

FIGS. 6A and 6B finally show a further embodiment of a loading station 9 according to the invention, in which a conveyor belt 21 driven by a drive unit 20 is provided on the upper side of each of the two loading tines 13 of the loading fork 12, with which a goods container 16 supported on the loading tines 13 can be transferred in the upper conveying level E₁ to a conveyor device 11 located directly in front of the loading fork 12 or with which a goods container 16 supplied in the upper conveying level E₁ by the conveyor device 11 can be suitably positioned on the loading tines 13 (with the aid of suitable stops). The double arrows P₁₈, P₁₉ show that the conveyor belt 21 can be moved in different directions in order to be able to move the goods container 16 on the loading fork 12 in different directions.

What is claimed is:

1. A method for loading a goods container (16) into a receiving container (2) mounted on an AGV (1) at a fixedly mounted loading station (9), wherein the loading station (9) has a lifting device (10) with a loading fork (12) with two loading tines (13) which can be moved vertically between an upper conveying level (E₁) and a lower conveying level (E₂), with the following steps:
positioning the loading fork (12) of the loading station (9) at a suitable height in the upper conveyor level (E₁) and transporting the goods container (16) to the loading station (9) in the upper conveyor level (E₁) by means of a conveyor device (11) until the goods container (16) is carried by the loading fork (12);
positioning of an AGV (1) travelling in the lower conveying plane (E₂) with a receiving container (2) mounted thereon for receiving the goods container (16) exactly below the goods container (16) carried by the loading fork (12) in the upper conveying level (E₁);
vertical lowering of the loading fork (12) and the goods container (16) located thereon into the receiving container (2) located below until the goods container (16) is supported on the underside in the receiving container (2) and until the loading tines (13) projecting into a lower section of the receiving container (2) no longer have any contact with the goods container (16) supported inside the receiving container (2), wherein the receiving container (2) has two vertical slots (V₁, V₂) in a side wall (3) extending from the upper edge of the wall (3) to the lower section to enable the loading fork (12) to be lowered; and
straight-ahead travel of the AGV (1) with the receiving container (2) located thereon and the goods container (16) located inside the receiving container (2) in the longitudinal direction of the loading tines (13) away from the loading station (9), so that the loading tines (13) of the stationarily mounted loading station (9) are moved out of the receiving container (2) due to the straight-ahead travel of the AGV (1).

2. A method for removing a goods container (16) from a receiving container (2) mounted on an AGV (1) at a fixedly mounted loading station (9), the loading station (9) having a lifting device (10) with a loading fork (12) with two loading tines (13) which can be moved vertically between an upper conveying level (E1) and a lower conveying level (E2), having the following steps:
positioning the loading fork (12) of the loading station at a suitable height in the lower conveyor level (E₂) and positioning an AGV (1) with a receiving container (2) mounted on it and the goods container (16) located inside the receiving container (2) in front of the loading station (9);
straight-ahead travel of the AGV in the longitudinal direction of the loading tines (13) towards the loading station, so that the loading tines (13) of the loading fork (12) enter a lower section of the receiving container (2) through vertical slots (V₁, V₂) in a side wall (3) of the receiving container (2) due to the straight-ahead travel of the AGV (1) below the goods container (16);
vertical lifting of the loading fork (12) up to the upper conveying level (E₁), so that the goods container (16) carried by the loading fork (12) during lifting is lifted upwards out of the receiving container(2) and lifted up to the upper conveying level (E₁), wherein the vertical slots (V₁, V₂) extend in a side wall (3) of the receiving container up to the upper edge of the wall (3) to enable the loading fork (12) to be lifted out; and
transfer of the goods container (16) to a conveyor device (11) located in the upper conveyor level (E₁) for further transport of the goods container (16) in the upper conveyor level (E₁).

3. A method for reloading goods delivered in goods containers (16′) into other goods containers (16) at a reloading station (18), comprising the following steps:
loading of a first goods container (16′) filled with the goods to be re-sorted into a receiving container (2′) mounted on a first AGV (1′) at a stationarily mounted loading station (9′) according to a method according to the method for loading a goods containers of claim 1;
loading of a second, empty goods container (16) into a receiving container (2) mounted on a second AGV (1) at a stationarily mounted loading station (9) according to the method for loading a goods container;
optionally, loading of at least one further empty or goods-filled goods container (16, 16′) into a respective receiving container (2, 2′) mounted on a further AGV (1, 1′) at a stationarily mounted loading station (9, 9′) according to the method;
moving the at least two AGVs (1, 1′) with the receiving containers and goods containers located thereon in the lower conveying level (E₂) to a reloading station (18);
manual or automatic reloading of goods from the first goods container (16′) into the second goods container (16) at the reloading station (18) and, optionally, reloading of further goods between the various goods containers (16, 16′) until the second goods container (16) is filled with the desired goods; and
after completion of the reloading of the goods, movement of the various AGVs (1, 1′) with receiving containers and goods containers to a loading station (9, 9′) and removal of the respective goods container (16, 16′) from the receiving container (2, 2′) mounted on the respective AGV (1, 1′), wherein such removal comprises:
positioning the loading fork (12) of the loading station at a suitable height in the lower conveyor level (E₂) and positioning the corresponding AGV (1) with the corresponding receiving container (2) mounted on it and the corresponding goods container (16) located inside the receiving container (2) in front of the loading station (9);
straight-ahead travel of the AGV in the longitudinal direction of the loading tines (13) towards the loading station, so that the loading tines (13) of the loading fork (12) enter a lower section of the receiving container (2) through vertical slots (V₁, V₂) in a side wall (3) of the receiving container (2) due to the straight-ahead travel of the AGV (1) below the goods container (16);
vertical lifting of the loading fork (12) up to the upper conveying level (E₁), so that the goods container (16) carried by the loading fork (12) during lifting is lifted upwards out of the receiving container(2) and lifted up to the upper conveying level (E₁), wherein the vertical slots (V₁, V₂) extend in a side wall (3) of the receiving container up to the upper edge of the wall (3) to enable the loading fork (12) to be lifted out; and
transfer of the goods container (16) to a conveyor device (11) located in the upper conveyor level (E₁) for further transport of the goods container (16) in the upper conveyor level (E₁).

4. A system for loading a goods container (16) into a receiving container (2) mounted on an AGV (1) and for removing a goods container (16) from a receiving container (2) mounted on an AGV (1), comprising:
a stationarily mounted loading station (9) with a lifting device (10), which has a loading fork (12) with two loading tines (13) that can be moved vertically between an upper conveyor level (E₁) and a lower conveyor level (E₂),
a conveyor device (11) for transporting goods containers in the upper conveyor level (E₁) to and from the loading station (9),
at least one AGV (1) movable in the lower conveying level (E₂) with a receiving container (2) mounted on it,
wherein the receiving container (2) has at least two vertical slots (V₁, V₂) in a side wall (3) extending up to the upper edge and is designed in such a way that:
for loading a goods container (16) into the receiving container (2) mounted on the AGV (1), the loading tines (13) of the lifting device (10) carrying a goods container (16) can be lowered vertically when the AGV (1) is suitably positioned, until the goods container (16) is supported on the underside in the receiving container (2) and until the loading tines (13) projecting into a lower section of the receiving container (2) through the vertical slots (V₁, V₂) no longer have any contact with the goods container (16) and can then be moved linearly out of the receiving container (2) by the AGV (1) travelling straight ahead, and
for removing a goods container (16) from the receiving container (2) mounted on the AGV (1), the loading tines (13) of the loading fork (12) can enter into a lower section of the receiving container (2) through the vertical slots (V₁, V₂) and can then be lifted together with the goods container (16) until the goods container (16) has been removed upwards from the receiving container (2).

5. The system of claim 4, wherein the clear width of the receiving container (2) is slightly larger than the outer dimensions of the goods container (16), so that when the goods container (16) is positioned centrally in the receiving container (2), there is a gap between the inner wall of the receiving container (2) and the outer wall of the goods container (16) accommodated therein.

6. The system of claim 5 further comprising a brush arrangement (8) at least largely closing the circumferential gap between the receiving container (2) and the goods container (16) is provided on the inner wall of the receiving container.

7. The system of claim 4, wherein the side walls of the receiving container (3, 4, 5, 6) project vertically beyond the walls of the goods container (16) accommodated in the receiving container (2).

8. The system of claim 4, wherein both loading tines (13) of the loading fork (12) have a motor-driven conveyor belt (21) on their upper side, with which a goods container (16) supported on the loading tines (13) can be transferred in the upper conveying level (E₁) to a conveying device (11) located directly in front of the loading fork (12) or with which a goods container (16) fed in the upper conveying level (E₁) by the conveying device (11) can be suitably positioned on the loading tines (13).
